(19) United States
(12) Patent Application Publication
(10) Pub. No.: US 2006/0277126 A1
(43) Pub. Date: Dec. 7, 2006

(54) Ring credit management

(75) Inventors: Mark B. Rosenbluth, Uxbridge, MA (US); Sridhar Lakshmanamurthy, Sunnyvale, CA (US)

Correspondence Address: CAVEN & AGHEVLI;c/o PORTFOLIOIP, P.O. BOX 52050, MINNEAPOLIS, MN, 55402, US

(73) Assignee: Intel Corporation

(21) Appl. No.: 11/145,676

(22) Filed: Jun. 6, 2005

(51) Int. Cl. G06Q 40/00

(52) U.S. Cl. 705/35

(57) ABSTRACT

Techniques that may be utilized in a multiprocessor computing system are described. In one embodiment, a request from a thread includes a credit parameter that may be used to update a credit register of a ring manager.

### BACKGROUND

As computers become more commonplace, an increasing amount of data is generated. To process this data in a timely fashion, parallel processing techniques may be utilized. For example, multiple threads or processes may be run on one or more processing elements simultaneously.

To collaborate effectively, the multiple threads may share information. For example, multiple threads may access a shared storage device. An example of shared storage devices is a first-in, first-out (FIFO) storage device. The FIFO device may be configured as a ring (or “circular buffer”), where a head pointer is used to read from the head of the ring and a tail pointer is used to write to the tail of the ring. Threads that write to a ring may be referred to as “producers” and threads that read from a ring may be referred to as “consumers.”

Generally, as the producers add content to the ring, the consumers take content off the ring to make additional space available for the producers. However, rings are finite storage devices. In some instances, producers may attempt to add content to the ring faster than consumers are able to take off the ring. Data loss would occur if producers are allowed to overfill a ring. Currently, a number of techniques are utilized to avoid overfilling rings.

One technique utilizes a status flag for each ring to indicate whether the ring is full. This technique may use sideband signals to communicate the status flag to the producers. Sideband signals, however, may not scale well as the number of rings are increased, in part, because valuable die real-estate may have to be used to provide the sideband signals. Also, a skid buffer may be employed to address the situations when multiple threads try to access the flag simultaneously, and start a write operation. The skid buffer is utilized only for a rarely occurring theoretical worse case resulting in a portion of the ring being rarely used, again wasting valuable die real-estate. Additionally, the flag may be periodically broadcast to the threads to inform them of the ring status. Hence, valuable communication bandwidth may be consumed by broadcasting the status flags to the threads. Moreover, dealing with the broadcasted information adds further overhead to the operation of the threads.

Another technique allows each producer to pre-allocate space on a ring before it is allowed to write information to the ring. The pre-allocated space is generally referred to as “credits” which may be implemented by using a shared variable stored in memory. Management of the credits is generally performed by the threads (e.g., in software). The overhead of managing credits adds inefficiencies to the operation of threads. Also, additional inefficiencies may result from utilization of mutual exclusion techniques to ensure that information is not corrupted by multiple threads accessing a shared variable at the same time.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates various components of an embodiment of a networking environment, which may be utilized to implement various embodiments discussed herein.

FIG. 2 illustrates a block diagram of a computing system in accordance with an embodiment.

FIG. 3 illustrates an embodiment of a multiple producer and multiple consumer system.

FIG. 4 illustrates an embodiment of a system that provides managed communication between multiple threads and rings.

FIG. 5 illustrates an embodiment of a method for managing communication between multiple threads and rings.

FIG. 6 illustrates an embodiment of a method for a write request performed by a producer thread.

### DETAILED DESCRIPTION

In the following description, numerous specific details are set forth in order to provide a thorough understanding of various embodiments. However, some embodiments may be practiced without the specific details. In other instances, well-known methods, procedures, components, and circuits have not been described in detail so as not to obscure the particular embodiments.

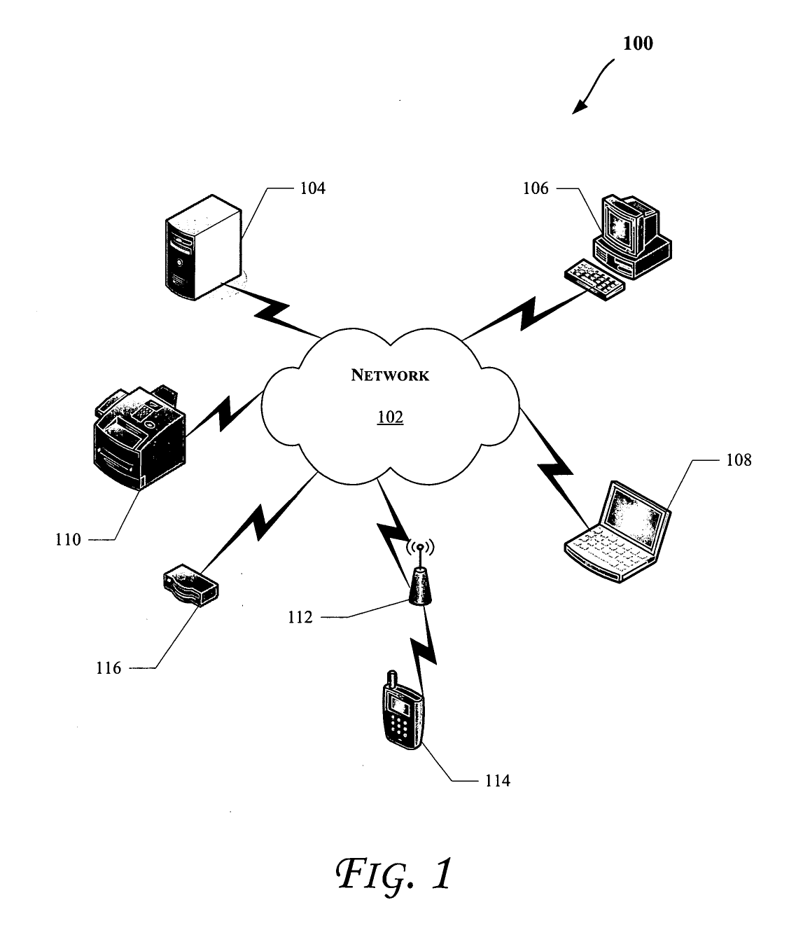

FIG. 1 illustrates various components of an embodiment of a networking environment 100, which may be utilized to implement various embodiments discussed herein. The environment 100 includes a network 102 to enable communication between various devices such as a server computer 104, a desktop computer 106 (e.g., a workstation or a desktop computer), a laptop (or notebook) computer 108, a reproduction device 110 (e.g., a network printer, copier, facsimile, scanner, all-in-one device, or the like), a wireless access point 112, a personal digital assistant or smart phone 114, a rack-mounted computing system (not shown), or the like. The network 102 may be any suitable type of a computer network including an intranet, the Internet, and/or combinations thereof.

The devices 104-114 may be coupled to the network 102 through wired and/or wireless connections. Hence, the network 102 may be a wired and/or wireless network. For example, as illustrated in FIG. 1, the wireless access point 112 may be coupled to the network 102 to enable other wireless-capable devices (such as the device 114) to communicate with the network 102. The environment 100 may also include one or more wired and/or wireless traffic management device(s) 116, e.g., to route, classify, and/or otherwise manipulate data (for example, in form of packets). In an embodiment, the traffic management device 116 may be coupled between the network 102 and the devices 104-114. Hence, the traffic management device 116 may be a switch, a router, combinations thereof, or the like that manages the traffic between one or more of the devices 104-114. In one embodiment, the wireless access point 112 may include traffic management capabilities (e.g., as provided by the traffic management devices 116).

The network 102 may utilize any suitable communication protocol such as Ethernet, Fast Ethernet, Gigabit Ethernet, wide-area network (WAN), fiber distributed data interface (FDDI), Token Ring, leased line (such as T1, T3, optical carrier 3 (OC3), or the like), analog modem, digital subscriber line (DSL and its varieties such as high bit-rate DSL (HDSL), integrated services digital network DSL (IDSL), or the like), asynchronous transfer mode (ATM), cable modem, and/or FireWire.

Wireless communication through the network 102 may be in accordance with one or more of the following: wireless local area network (WLAN), wireless wide area network (WWAN), code division multiple access (CDMA) cellular radiotelephone communication systems, global system for mobile communications (GSM) cellular radiotelephone systems, North American Digital Cellular (NADC) cellular radiotelephone systems, time division multiple access (TDMA) systems, extended TDMA (E-TDMA) cellular radiotelephone systems, third generation partnership project (3G) systems such as wide-band CDMA (WCDMA), or the like. Moreover, network communication may be established by internal network interface devices (e.g., present within the same physical enclosure as a computing system) or external network interface devices (e.g., having a separated physical enclosure and/or power supply than the computing system it is coupled to) such as a network interface card (NIC).

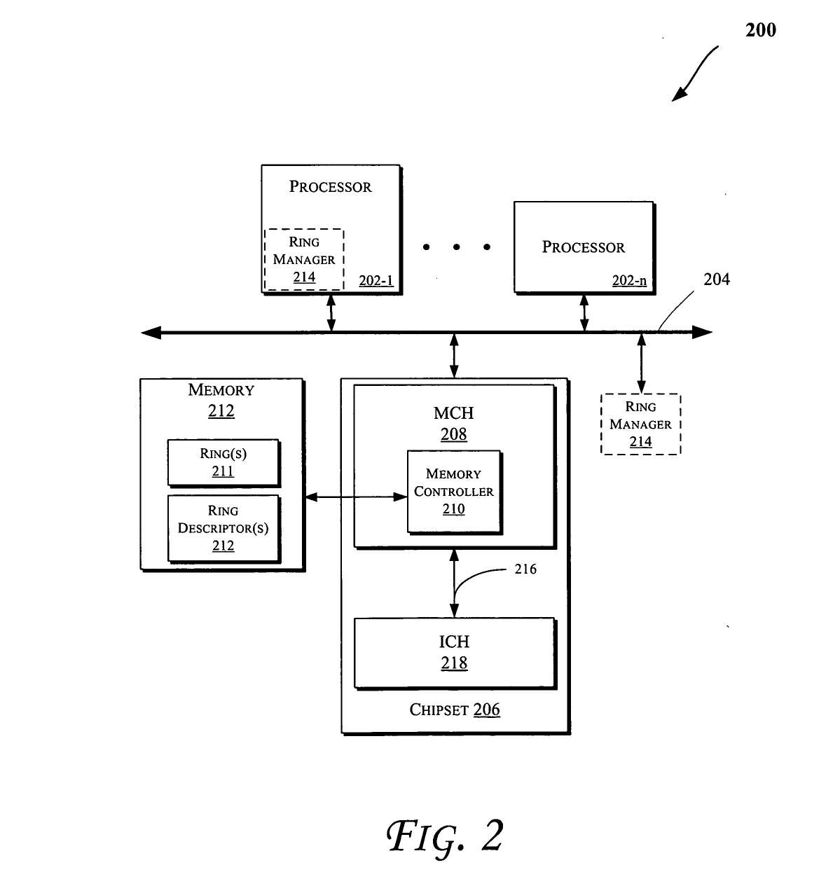

FIG. 2 illustrates a block diagram of a computing system 200 in accordance with an embodiment of the invention. The computing system 200 may be utilized to implement one or more of the devices (104-116) discussed with reference to FIG. 1. The computing system 200 includes one or more processors 202 (e.g., 202-1 through 202-n) coupled to an interconnection network (or bus) 204. The processors (202) may be any suitable processor such as a general purpose processor, a network processor, or the like (including a reduced instruction set computer (RISC) processor or a complex instruction set computer (CISC)). Moreover, the processors (202) may have a single or multiple core design. The processors (202) with a multiple core design may integrate different types of processor cores on the same integrated circuit (IC) die. Also, the processors (202) with a multiple core design may be implemented as symmetrical or asymmetrical multiprocessors. In one embodiment, the processors (202) may be network processors with a multiple-core design which includes one or more general purpose processor cores (e.g., microengines (MEs)) and a core processor (e.g., to perform various general tasks within the network processor).

A chipset 206 may also be coupled to the interconnection network 204. The chipset 206 may include a memory control hub (MCH) 208. The MCH 208 may include a memory controller 210 that is coupled to a memory 212 that may be shared by the processors 202 and/or other devices coupled to the interconnection network 204. The memory 212 may store data and/or sequences of instructions that are executed by the processors 202, or any other device included in the computing system 200.

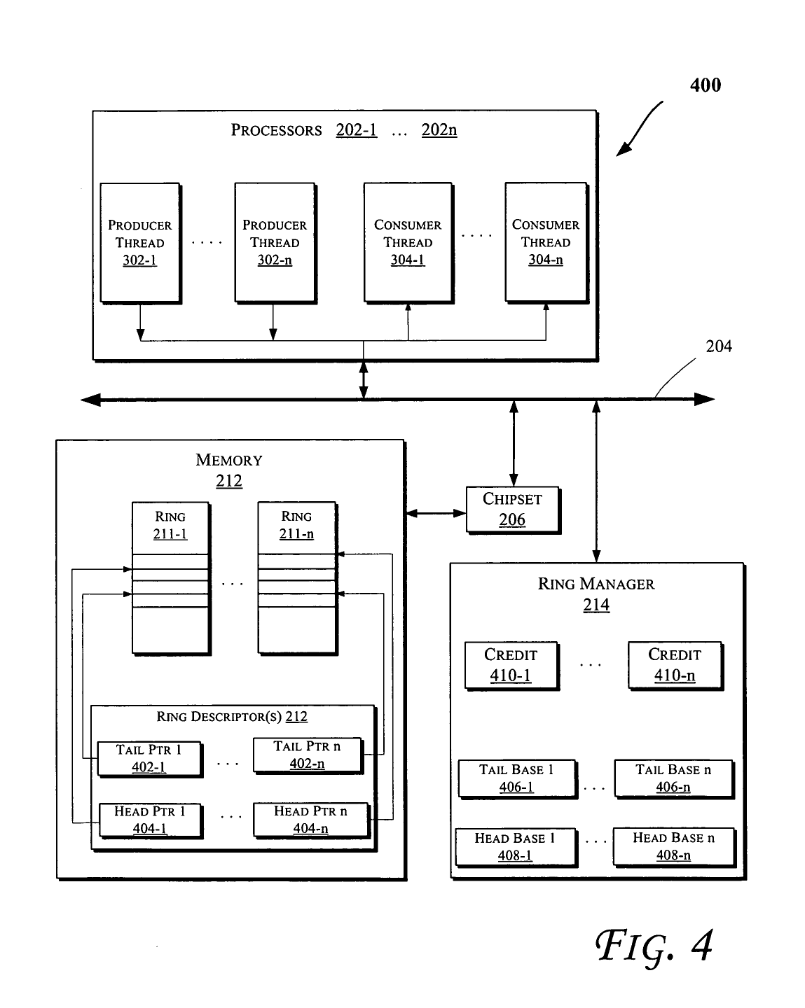

The memory 212 may store data corresponding to one or more ring arrays (or rings) 211 and associated ring descriptors 212. The rings 211 may be FIFO storage devices that are configured as circular buffers to share data between various components of the system 200 (also referred to as “agents”), including the processors 202, and/or various devices coupled to the ICH 218 or the chipset 206. The ring descriptors 212 may be utilized for reading and/or writing data to the rings (211), as will be further discussed with reference to FIG. 4. The system 200 may also include a ring manager 214 coupled to the interconnection network 204, e.g., to manage the rings 211 and the ring descriptors 212, as will be further discussed with reference to FIG. 4. As illustrated in FIG. 2, the ring manager 214 may be implemented in one of the processors 202 (e.g., the processor 202-1). For example, in an embodiment that utilizes the system 200 as a network processor, the ring manager 214 may be implemented inside a core processor of the network processor.

In an embodiment, the memory 212 may include one or more volatile storage (or memory) devices such as random access memory (RAM), dynamic RAM (DRAM), synchronous DRAM (SDRAM), static RAM (SRAM), or the like. Moreover, the memory 212 may include nonvolatile memory (in addition to or instead of volatile memory). Hence, the computing system 200 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 228), a floppy disk, a compact disk ROM (CD-ROM), a digital versatile disk (DVD), flash memory, a magneto-optical disk, or other types of nonvolatile machine-readable media suitable for storing electronic instructions and/or data. Additionally, multiple storage devices (including volatile and/or nonvolatile memory discussed above) may be coupled to the interconnection network 204.

As illustrated in FIG. 2, a hub interface 216 may couple the MCH 208 to an input/output control hub (ICH) 218. The ICH 218 may provide an interface to input/output (I/O) devices coupled to the computing system 200. For example, the ICH 218 may be coupled to a peripheral component interconnect (PCI) bus to provide access to various peripheral devices. Other types of topologies or buses may also be utilized. Examples of the peripheral devices coupled to the ICH 218 may include integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), one or more audio devices (such as a Moving Picture Experts Group Layer-3 Audio (MP3) player), a microphone, speakers, or the like), one or more network interface devices (such as a network interface card), or the like.

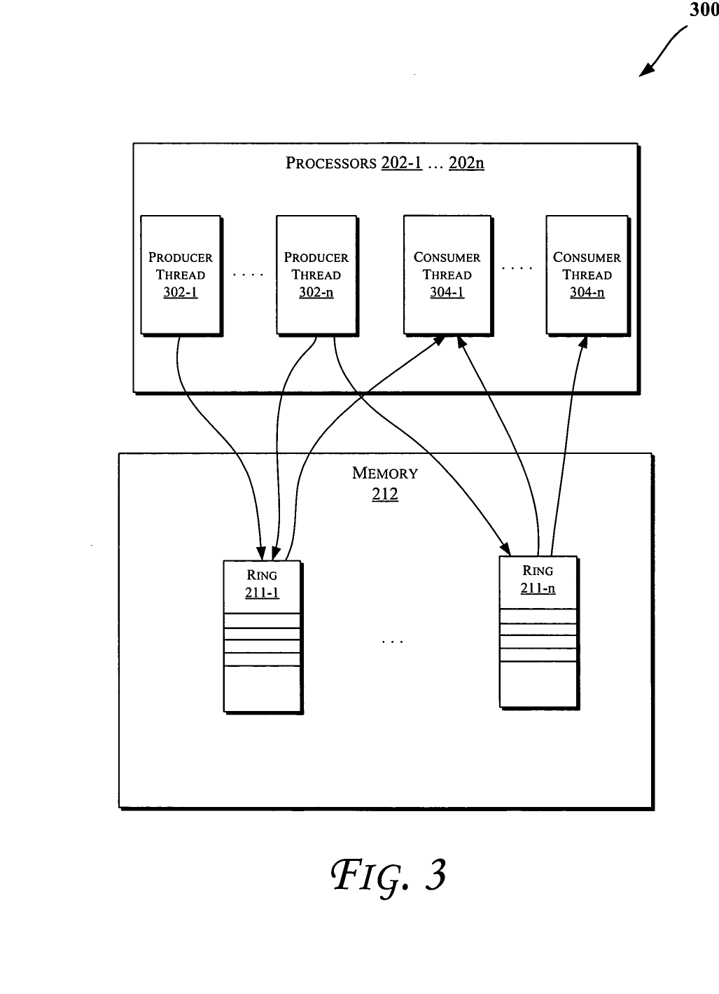

FIG. 3 illustrates an embodiment of a multiple producer and multiple consumer system 300. The system 300 may be implemented by utilizing the computing system 200 of FIG. 2, in an embodiment. As illustrated in FIG. 3, one or more producer threads (302-1 through 302-n) and consumer threads (304-1 through 304-n) may be running on one or more processors (202). Each of the producers (302) may write data to one or more rings (211). Also, each of the consumers 304 may read data from one or more rings (211). The data that is written by the producers 302 or read by the consumers 304 may be any suitable data including messages, pointers, or other type of information that may be exchanged between threads. As illustrated in FIG. 3, the rings 211 may be implemented in the memory 212 such as discussed with reference to FIG. 2.

FIG. 4 illustrates an embodiment of a system 400 that provides managed communication between multiple threads and rings. In one embodiment, the traffic management devices 116 discussed with reference to FIG. 1 may include the system 400. The ring descriptors 212 may include a tail pointer 402 for each ring (211) to indicate where data may be written (or added) to the ring (211) and a head pointer 404 for each ring (211) to indicate where data may be read from the ring (211). The ring manager 214 may include various control and status registers (CSRs) to store ring configuration parameters, such as ring size and base values for ring descriptors (212). For example, tail base registers (or CSRs) 406-1 through 406-n may store base values of the corresponding tail pointers 402-1 through 402-n, respectively. Similarly, head base registers (or CSRs) 408-1 through 408-n may store base values of the corresponding head pointers 404-1 through 404-n, respectively.

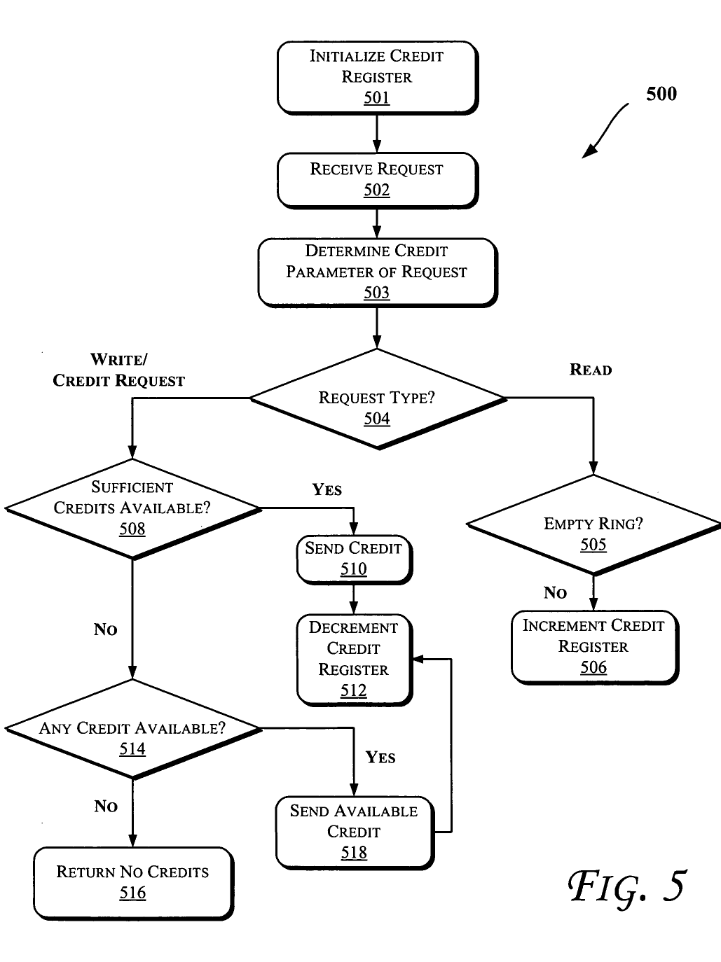

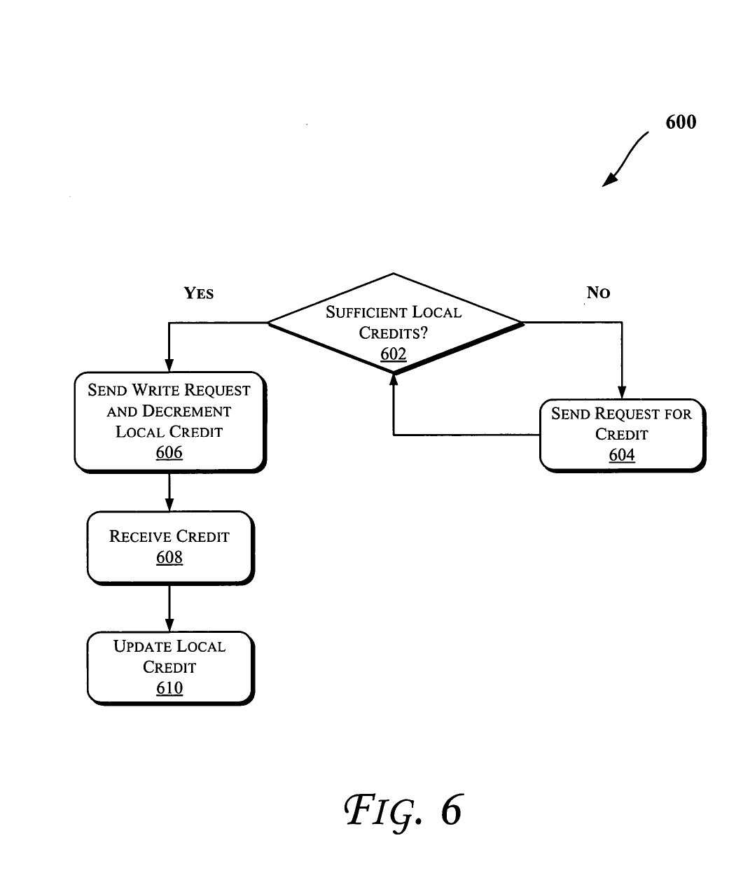

The ring manager 214 may also include one or more credit registers (or CSRs) 410. Each of the credit registers 410 may store the value of credits available for a given ring (211). Also, a plurality of credit values corresponding to a plurality of rings may be stored in a memory device (e.g., 212) and the credit value of the ring may be moved to a working credit register (e.g., the credit register 410-1) in response to receiving a request that identifies a corresponding ring. The request may be a read, write, or get credit request as will be further discussed with reference to FIGS. 5 and 6. Accordingly, the credit values may indicate the number of free locations available on each ring (211). The initial value of the credit registers 410 (e.g., upon system startup or reset) may be the size of the corresponding ring (211). In one embodiment, the credit registers 410 may be implemented by storing the credit values corresponding to a plurality of rings (211) in shared memory (e.g., the memory 212). The credit values may be individually moved into a working credit register (410), e.g., by hardware (such as the ring manager 214), as each ring (211) is accessed. Furthermore, the value of the credit registers 410 may be updated as producer threads 302 write to the rings 211 or as consumer threads 304 read data from the rings 211. As will be further discussed with reference to FIG. 5, the value of a credit register (410) may also be updated upon a request by a producer thread (304) to allocate additional credit to that producer. The data communicated between the threads (302 and 304) and the rings (211) may be communicated via the interconnection network 204 (e.g., through the chipset 206), such as discussed with reference to FIG. 2.

FIG. 5 illustrates an embodiment of a method 500 for managing communication between multiple threads and rings. In one embodiment, the system 400 of FIG. 4 may be utilized to perform one or more operations discussed with reference to the method 500. At a stage 501, a ring manager (e.g., the ring manager 214) initializes a credit register (e.g., the credit register 410). The initialization may be performed by a CSR write command, in accordance with at least one instruction set architecture.

After receiving a ring access request from a thread (502), a stage 503 determines a credit parameter that may be included with the request. The ring access request may be a read, write, or credit request as will be further discussed below. Also, as a ring is read from or written to, the corresponding head and tail pointers (402 and 404) and registers (406 and 408) may be updated to enable the correct operation of future read and/or write requests. The credit parameter may be any suitable parameter corresponding to the credit value of the ring (211) to which the ring access request is directed. For example, the credit parameter may be the length of the message in the request, a credit request, or the like as will be further discussed below. The request may be a command sent by the threads 302 or 304 of FIG. 3. Additionally, as will be further discussed herein (e.g., with respect to stages 505-506 and 508-518), the ring manager 214 may determine whether to update (e.g., increment or decrement) the credit register 410 in response to the credit parameter (503) in one embodiment.

In one embodiment, the ring manager 214 may monitor the data communicated via the interconnection network 204 to receive the request (502) and determine the message length (503). Also, the ring manager 214 may perform a stage 504, which determines the type of the request.

If the request is a read request and the corresponding ring is not empty (505), the credit register 410 may be incremented (506), e.g., by the length of the message sent. If the ring is empty (505), the credit register 410 of that ring will be left unchanged. Also, the stage 506 may increment the credit register 410 of the ring to the maximum ring size, such as discussed with reference to the stage 501. In one embodiment, the following pseudo code may be utilized for a read (or get) request:
GET (ring identifier, message, message_length)

Accordingly, a consumer thread (304) may issue a read command that includes a ring identifier (e.g., ring identifier) that identifies a specific ring (211) from which the data is to be read; a message field (e.g., message) that would contain the contents read from the ring; and a message length field (e.g., message_length). Hence, the ring manager 214 may perform any updating of the credit register 410 without further information from the consumer thread (304) that issues the read request.

If the request is a write request or a credit request (504), a ring manager (e.g., 214) may determine whether sufficient credits are available (508). In one embodiment, the read request or the credit request may include information about how much credit a thread (e.g., the producer threads 302) is requesting. For example, the following pseudo code may be utilized for a credit request:
GET_CREDIT (ring_identifier, requested_credit, return_credit)

Accordingly, a producer thread (302) may issue a credit request command that includes a ring identifier (e.g., ring_identifier) that identifies a specific ring (211) for which credit is to be allocated; a requested credit amount (e.g., requested_credit); and a returned credit amount (e.g., return_credit), e.g., the amount of credit that is sent by the ring manager 214 (as will be further discussed below with reference to stages 510 and 518).

In the stage 508, if the requested credits are available (e.g., as determined by a ring manager that compares the value of the credit register 410 against the requested credits), a ring manager (e.g., 214) sends the requested credits to the requesting thread (510). The requesting thread may be a producer thread (302) as will be further discussed with reference to FIG. 6. In a stage 512, a ring manager (e.g., 214) may decrement a credit register (e.g., 410) by the number of sent credits (510). Alternatively, if a ring manager (e.g., 214) determines that sufficient credits are unavailable (508), the ring manager may determine if any credits are available (514). The stage 514 may be performed by a ring manager (e.g., 214) that determines whether the value of the credit register 410 is greater than 0. If no credits are available (e.g., the value of the credit register 410 is null), the ring manager (214) returns no credits. Otherwise, the ring manager (214) may send some or all of the available credits to the requesting thread (e.g., the producer threads 302). The ring manager (214) may further decrement a credit register (e.g., the credit register 410) by the number of sent credits (510) in the stage 518.

FIG. 6 illustrates an embodiment of a method 600 for a write request performed by a producer thread. In one embodiment, the system 400 of FIG. 4 may be utilized to perform one or more operations discussed with reference to the method 600. Prior to issuing a write request, a producer thread (302) determines (602) whether sufficient local credits are available for writing a message to a ring (211). The local credits may be stored on local memory of a processor (202) that is running the producer thread (302). Alternatively, the local credits may be stored elsewhere in the system 400 of FIG. 4, such as in the memory 212 and/or in registers within the ring manager 214. Also, upon initialization (e.g., upon system startup or reset), each producer thread (302) may request some number of credits for its local credit. Such an implementation may avoid latencies associated with requesting credit (such as discussed with reference to FIG. 5) prior to issuing the first write request.

If the producer thread determines sufficient amount of local credit is unavailable (602), the producer may send a request for credit (604) to a ring manager (e.g., 214), such as discussed with reference to FIG. 5. Hence, the message may be held until further credit is available. Alternatively, the message may be discarded. Otherwise, if the producer (302) determines that sufficient local credits are available (602) the producer may send a write request and decrement the producer's local credit (606), receive the returned credit (608), and update its local credit count (610) (e.g., by incrementing the producer's local credit in response to the returned credit of the stage 608). As discussed with reference to FIG. 5, a ring manager (e.g., 214) may send the returned credit (608). Accordingly, some of the embodiments discussed with reference to FIG. 6 may limit the latency associated with the implementations that wait for a success or failure parameter after issuing a write request. This is in part because a producer thread (302) checks for sufficient credits (602) prior to sending a write request (606). Hence, the used credits are replaced (608-610) as a side-effect of the write request, which is outside of the critical section code (resulting in less latency during operation of the producer threads 302).

In one embodiment, the write request (or command) may include information about how much credit the producer thread (302) is requesting. For example, the following pseudo code may be utilized for a write (or put) request:
PUT (ring_identifier, message, message_length, return_credit)

Accordingly, a producer thread (302) may issue a write request command that includes a ring identifier (e.g., ring_identifier) that identifies a specific ring (211) to which data is to be written; a message field (e.g., message) that would contain the contents to write to the ring; a message length field (e.g., message_length); and a returned credit field (e.g., return_credit) to receive the amount of the returned credit (e.g., by the ring manager 214 such as discussed with reference to FIG. 5).

In one embodiment, the returned amount of credit may be the same as the message length, assuming the corresponding credit register (410) has sufficient credit (such as discussed with reference to FIG. 5). Alternatively, the ring manager (214) may return more or less credits depending on the implementation. Also, the producer thread (302) may request (e.g., through a request field) more or less credits than the message length depending on various factors such as the amount of input traffic to the thread. For example, when a producer thread (302) observers that input traffic is bursty or asymmetric, it may request more credits to be replenished than the message length (for example 2*message_length). Alternatively, when a producer thread (302) observers that input traffic is sparse, it may request no credits to be replenished. For each case, the ring manager 214 may return the value requested if sufficient credits are available, or available credits if the requested value is not available (such as discussed with reference to FIG. 5).

Accordingly, in one embodiment, techniques discussed herein such as those of FIGS. 3-6 allow a producer thread (302) to request or prefetch a smaller amount of credit than with a purely software scheme (e.g., without the ring manager 214 and/or the credit register 410). With the software credit scheme (e.g., where threads manage the credits), there may be motivation for each producer to prefetch a large number of credits, so as to minimize contentions in accessing the shared credit variable. In an embodiment, such as discussed with reference to FIGS. 4-6 the credit register 410 is accessed during puts or gets, which are already serialized by the ring manager 214, in part, because the ring memory (212) may be either read or written at a given time, not both. Therefore, there is less motivation to prefetch a large amount of credit. The producers may request a sufficient amount of credit with each write request to cover the latency associated with replenishing their local credits for future write operations. Also, using a smaller prefetch may minimize the situation where one producer thread is starved of credits because other producer threads have prefetched credits beyond their needs.

In various embodiments, the operations discussed herein, e.g., with reference to FIGS. 1-6, may be implemented as hardware (e.g., logic circuitry), software, firmware, or combinations thereof, which may be provided as a computer program product, e.g., including a machine-readable or computer-readable medium having stored thereon instructions used to program a computer to perform a process discussed herein. The machine-readable medium may include any suitable storage device such as those discussed with reference to FIGS. 2 and 4.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with that embodiment may be included in an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method comprising:
receiving a request from a thread;
determining a credit parameter of the request; and
determining whether to update a dedicated credit register in a ring manager that manages one or more rings in response to the credit parameter.

2. The method of claim 1, wherein receiving the request from the thread comprises receiving a write request or a get credit request from a producer thread.

3. The method of claim 2, further comprising sending a returned credit to the producer thread.

4. The method of claim 3, further comprising decrementing the credit register by a value of the returned credit.

5. The method of claim 3, further comprising determining a value of the returned credit based on available credits in the credit register.

6. The method of claim 3, further comprising determining a value of the returned credit based on available credits in the credit register and a length of a message of the request.

7. The method of claim 3, further comprising the producer thread updating a local credit of the producer thread based on a value of the returned credit.

8. The method of claim 2, further comprising the producer thread determining whether sufficient producer local credits are available prior to sending the write request.

9. The method of claim 1, wherein receiving the request from the thread comprises receiving a read request from a consumer thread.

10. The method of claim 9, further comprising incrementing the credit register by a length of a message of the read request if the credit register is not at a maximum size of a corresponding ring.

11. The method of claim 1, wherein a plurality of credit values corresponding to a plurality of rings are stored in a memory device and a credit value of a ring is moved to the credit register in response to receiving a request that identifies a corresponding ring.

12. An apparatus comprising:
a processor to run a thread; and
a ring manager coupled to the processor to:
receive a request from the thread;
determine a credit parameter of the request; and
determine whether to update a dedicated credit register in the ring manager that manages one or more rings in response to the credit parameter.

13. The apparatus of claim 12, wherein the thread is a producer thread or a consumer thread and the credit parameter is a length of a message of the request.

14. The apparatus of claim 12, wherein the thread is a producer thread and the credit parameter is a requested amount of credit.

15. The apparatus of claim 12, wherein the thread is a producer thread and the ring manager sends a returned credit to the producer thread based on available credits in the credit register.

16. The apparatus of claim 12, wherein the ring manager is implemented in a processor of a multiprocessor computing system.

17. The apparatus of claim 16, wherein the multiprocessor computing system is a symmetrical multiprocessor or an asymmetrical multiprocessor.

18. The apparatus of claim 16, wherein the multiprocessor computing system is a network processor.

19. The apparatus of claim 12, wherein the request is:
a write request to write data to a ring stored in a memory device coupled to the processor;
a read request to read data from the ring; or
a get credit request to obtain additional credit for the thread.

20. The apparatus of claim 12, wherein the ring manager is coupled to the thread via an interconnection network.

21. The apparatus of claim 12, wherein the ring manager comprises a plurality of credit registers.

22. A traffic management device comprising:
one or more volatile memory devices to store information corresponding to one or more rings; and
a multiprocessor computing system to:
receive a request from a thread;
determine a credit parameter of the request; and
determine whether to update a dedicated credit register in a ring manager that manages one or more rings in response to the credit parameter.

23. The device of claim 21, wherein the one or more volatile memory devices are one or more of a RAM, DRAM, SRAM, and SDRAM.

24. A computer-readable medium comprising:
stored instructions to receive a request from a thread;
stored instructions to determine a credit parameter of the request; and
stored instructions to determine whether to update a dedicated credit register in a ring manager that manages one or more rings in response to the credit parameter.

25. The computer-readable medium of claim 24, further comprising stored instructions to send a returned credit to the producer thread.
